(19) United States
(12) Patent Application Publication
(10) Pub. No.: US 2026/0167831 A1
(43) Pub. Date: Jun. 18, 2026

(54) EPOXY RUST-TOLERANT COATING MODIFIED BY NANOSHEETS LOADED WITH RUST-CONVERTING AND RUST-INHIBITING ACTIVE UNITS AND PREPARATION METHOD THEREOF

(71) Applicant: China Academy of Machinery Wuhan Research Institute of Materials Protection Co.,Ltd, Wuhan (CN)

(72) Inventors: Dan Jia, Wuhan (CN); Yijie Jin, Wuhan (CN); Haitao Duan, Wuhan (CN); Shengpeng Zhan, Wuhan (CN); Ao Chen, Wuhan (CN); Tian Yang, Wuhan (CN); Jinming Ma, Wuhan (CN); Xiaoshuang Luo, Wuhan (CN); Jingqi Huang, Wuhan (CN)

(21) Appl. No.: 19/363,597

(22) Filed: Oct. 20, 2025

(30) Foreign Application Priority Data
Dec. 12, 2024 (CN) 202411823282.5

(51) Int. Cl. C09D 5/08; C09D 7/20; C09D 7/61; C09D 7/63; C09D 7/65; C09D 163/00

(52) U.S. Cl. CPC C09D 5/084; C09D 7/20; C09D 7/61; C09D 7/63; C09D 7/65; C09D 163/00

(57) ABSTRACT

A preparation method of an epoxy rust-tolerant coating modified by nanosheets loaded with rust-converting and rust-inhibiting active units is provided. Strontium chloride, phytic acid and boron nitride are mixed in aqueous solution, transferred to a hydrothermal reactor to prepare strontium phytate-modified boron nitride nanosheets. A defoamer, a dispersant, a leveling agent and an anti-rust filler are added to epoxy resin. Then composite nanosheets are added, supplemented by a diluent, filtered and encapsulated to obtain a component A. A composite amine epoxy curing agent and a flash rust inhibitor are mixed and stirred to obtain a component B. The coating is obtained by mixing the stirred component A and the component B. Multifunctional nanosheets with multiple synergistic effects of barrier shielding, passivation stabilization and chelation conversion are made through a one-step method, which greatly enhances rust-conversion and rust-inhibition capabilities of the epoxy rust-tolerant coating, and has broad application prospects.

### TECHNICAL FIELD

The disclosure relates to the field of coating technologies, in particular to an anti-corrosion epoxy resin coating, and more particularly to an epoxy rust-tolerant coating modified by nanosheets loaded with rust-converting and rust-inhibiting active units and a preparation method thereof.

### BACKGROUND

Steel is the foundation of human industrial civilization, but it is also one of the main sources of carbon emissions. According to the World Steel Association, the average carbon emission per ton of steel in the world is about 1.85 tons. In addition, according to statistics, there are nearly ¼ of the total output of rusted steel substrate every year in the world. The direct economic loss caused by corrosion is about 700 billion USD. The economic loss caused by corrosion in China accounts for about 4% of the gross national product. Therefore, the rational utilization of rusted steel substrates is the key to energy saving and emission reduction. The protection and life extension of the rusted steel substrates have positive significance for energy saving and emission reduction. Coating with a rust-tolerant coating is one of the most effective methods for reusing the rusted steel substrates. Rust-inhibiting active units in the rust-tolerant coating inhibit convert or inhibit the rusted steel substrates to slow down the further corrosion of dynamic mechanism. However, the direct incorporation of the rust-inhibiting active units has poor compatibility with the rust-tolerant coating, and there will be problems of failure such as accelerated corrosion caused by excessive incorporation and easy loss of environmental effects. The problems are mainly attributed to the random free diffusion of the rust-inhibiting active units. Therefore, how to construct a long-term slow release system of the rust-inhibiting active units and prolong the service life of the rusted steel substrate is a key technology that is lacking when applying the rust-tolerant coating to the rusted steel substrate.

By preparing nanosheets loaded with rust-converting and rust-inhibiting active units first and then adding the nanosheets to epoxy resin, an epoxy rust-tolerant coating that can slowly release the rust-converting and rust-inhibiting active units can be obtained. In this situation, the problem of rapid diffusion failure of the rust-inhibiting active units can be effectively solved, the workload of pretreatment of the rusted steel substrate can be greatly reduced, and the industrial application prospects of the rust-tolerant coating can be expanded.

### SUMMARY

An objective of embodiments of the disclosure is to provide an epoxy rust-tolerant coating modified by nanosheets loaded with rust-converting and rust-inhibiting active units and a preparation method thereof. Strontium chloride, phytic acid and boron nitride are used as raw materials to prepare the boron nitride nanosheets loaded with strontium phytate by a one-step hydrothermal reaction to solve the problem of diffusion failure of rust-inhibiting active units and overcome the tedious rust removal process. In this case, the long-term release of corrosion inhibitor is realized, the corrosion protection performance of the epoxy rust-tolerant coating is strengthened, and a material of the epoxy rust-tolerant coating with barrier shielding, passivation stabilization, and chelation conversion is formed.

In order to achieve the above objective, technical solutions adopted by the disclosure are as follows.

The disclosure provides a preparation method of an epoxy rust-tolerant coating modified by nanosheets loaded with rust-converting and rust-inhibiting active units, including the following steps:
step 1, preparing nanosheets loaded with rust-converting and rust-inhibiting active units by the one-step hydrothermal reaction, including: mixing strontium chloride and phytic acid in deionized water in a beaker to obtain a mixed solution, adding boron nitride (BN) nanosheets into the mixed solution, followed by stirring to obtain a mixture, transferring the mixture into a reactor with tetrafluoroethylene, reacting at 150 Celsius degrees (° C.) for 12 hours (h) to obtain a reaction product; washing and drying the reaction product to obtain strontium phytate-modified boron nitride nanosheets (SrPA/BN) as the nanosheets loaded with rust-converting and rust-inhibiting active units;
step 2, adding a wetting agent, a leveling agent, a defoamer, an anti-rust filler and a diluent to an epoxy resin, followed by grinding for 1 h to obtain a grounded product, dispersing the grounded product with the SrPA/BN for 20 minutes (min) to obtain a dispersed product, and filtering and packaging the dispersed product to obtain a component A of the epoxy rust-tolerant coating;
step 3, mixing and stirring a composite amine epoxy curing agent and a flash rust inhibitor to obtain a component B of the epoxy rust-tolerant coating; and
step 4, mixing the component A and the component B to obtain the epoxy rust-tolerant coating modified by the nanosheets loaded with rust-converting and rust-inhibiting active units configured to be coated directly on a rusted steel substrate.

In some embodiments, a formula of the epoxy rust-tolerant coating is composed of the component A and the component B. The component A is made of raw materials in parts by weight comprising: 30-50 parts of the epoxy resin, 0.1-5 parts of the SrPA/BN, 5-30 parts of the anti-rust filler, 0.5-3 parts of dispersant, 1-3 parts of the defoamer, 0.5-5 parts of the leveling agent, 5-15 parts of the diluent. The component B is made of raw materials in parts by weight comprising: 5-15 parts of the composite amine epoxy curing agent and 0-3 parts of the flash rust inhibitor.

In the embodiment, the epoxy resin is at least one of bisphenol A epoxy resin and bisphenol F epoxy resin.

In the embodiment, the anti-rust filler is at least one of barium sulfate and titanium dioxide.

In the embodiment, the dispersant is at least one selected from the group consisting of anionic polymeric compound, polymeric carboxylic acid, and siloxane copolymer.

In the embodiment, the defoamer is polyacrylate.

In the embodiment, the leveling agent is polyether-modified polysiloxane.

In the embodiment, the diluent is a mixture of xylene and n-butanol.

In the embodiment, the composite amine epoxy curing agent is any two or multiple selected from the group consisting of polyamide, aliphatic amines and aromatic amine.

The principle of the disclosure is as follows.

This disclosure uses the strontium chloride, the phytic acid and the boron nitride as raw materials to prepare the SrPA/BN by the one-step hydrothermal reaction. Specifically, the phytic acid and the strontium chloride are mixed in a certain molar ratio (i.e., the molar ratio of the strontium chloride to the phytic acid is 6:1, the phytic acid is rich in 6 phosphate groups, and strontium ions in the strontium chloride are divalent ions) to generate the strontium phytate in the hydrothermal environment, and then the boron nitride nanosheets are added in the reaction process, so as to form the SrPA/BN. The boron nitride nanosheets have excellent chemical stability and physical barrier ability. A maze is set up through a metal surface to prolong the diffusion path of a corrosive medium and slow down the occurrence of corrosion. The boron nitride has good electrical insulation. When used for metal protection, the boron nitride can prevent the transmission of electrons between the metal surface and the corrosive medium, thereby slowing down a metal corrosion rate. A molecular structure of the strontium phytate contains multiple negatively charged phosphate groups. These groups can undergo a strong chelation reaction with a metal substrate (e.g., iron substrate) to form a stable complex. In this process, the strontium ions are released and adsorbed on the surface of the iron substrate by physical adsorption to form an adsorption film. This film can prevent the direct contact of corrosive media such as oxygen and water with a surface of the iron substrate, thereby slowing down the corrosion rate of the iron substrate.

The beneficial effects of the disclosure are as follows.
(1) The disclosure provides a simple preparation method using the strontium chloride, the phytic acid and the boron nitride as the raw materials. The SrPA/BN is prepared by the one-step hydrothermal reaction, avoiding the problem of rapid diffusion and failure of the rust-converting and rust-inhibiting active units directly added to the epoxy rust-tolerant coating.
(2) This disclosure provides the epoxy rust-tolerant coating modified by the nanosheets loaded with rust-converting and rust-inhibiting active units that shows the advantages of the combination of the boron nitride, the phytic acid and the strontium ions. The epoxy rust-tolerant coating modified by the nanosheets loaded with rust-converting and rust-inhibiting active units has multiple synergistic effects of barrier shielding, passivation stabilization and chelation conversion, greatly prolongs the service life of the coating and can shorten the coating and maintenance cycle of the rusted substrate.

### BRIEF DESCRIPTION OF DRAWINGS

FIG. 1 is a scanning electron microscopy (SEM) image of strontium phytate-modified boron nitride nanosheets (SrPA/BN).

FIG. 2 is a SEM image of boron nitride nanosheets.

FIG. 3 is a photograph of a morphology of a rusted steel substrate used in the disclosure.

FIG. 4 is a morphology of neutral salt spray of the epoxy rust-tolerant coating modified by the nanosheets loaded with rust-converting and rust-inhibiting active units after being cured for 600 h according to an embodiment 1 of the disclosure.

FIG. 5 is a morphology of neutral salt spray of an epoxy rust-tolerant coating modified by the boron nitride nanosheets after being cured for 600 h according to a comparative embodiment 1 of the disclosure.

### DETAILED DESCRIPTION OF EMBODIMENTS

The following will be combined with the drawings of the embodiments to clearly and completely describe technical solutions of an epoxy rust-tolerant coating modified by nanosheets loaded with rust-converting and rust-inhibiting active units and a preparation method thereof provided by the disclosure. The specific embodiments described herein are only used to explain the disclosure and are not used to limit the disclosure.

### Embodiment 1

In step 1, nanosheets loaded with rust-converting and rust-inhibiting active units are prepared by a one-step hydrothermal reaction. Specifically, 4.76 grams (g) strontium chloride and 1.36 milliliters (mL) phytic acid are mixed in a beaker filled with 100 mL deionized water to obtain a mixed solution, and the mixed solution is added with 4.96 g boron nitride (BN) nanosheets, followed by stirring to obtain a mixture. The mixture is transformed into a reactor with tetrafluoroethylene, reacting at 150 Celsius degrees (° C.) for 12 hours (h) to obtain a reaction product. The reaction product is washed for three times and dried at 60° C. for 24 h to obtain strontium phytate-modified boron nitride nanosheets (SrPA/BN).

In step 2, 2 parts of wetting agent, 2 parts of leveling agent, 3 parts of defoamer, 20 parts of anti-rust filler and 10 parts of diluent are added to 50 parts of epoxy resin in a predetermined ratio, followed by grinding for 1 h to obtain a grounded product. Then the grounded product is dispersed with the 2 parts of SrPA/BN for 20 minutes (min) to obtain a dispersed product. The dispersed product is filtered and packaged to obtain a component A of the epoxy rust-tolerant coating.

In step 3, 10 parts of composite amine epoxy curing agent and 1 part of flash rust inhibitor are mixed and stirred in a predetermined ratio to obtain a component B of the epoxy rust-tolerant coating.

In step 4, the component A and the component B are mixed to obtain the epoxy rust-tolerant coating modified by the nanosheets loaded with rust-converting and rust-inhibiting active units configured to be coated directly on a rusted steel substrate.

### Embodiment 2

In step 1, nanosheets loaded with rust-converting and rust-inhibiting active units are prepared by a one-step hydrothermal reaction. Specifically, 7.14 g strontium chloride and 2.72 mL phytic acid are mixed in a beaker filled with 100 mL deionized water to obtain a mixed solution, and the mixture solution is added with 4.96 g BN nanosheets, followed by stirring to obtain a mixture. The mixture is transformed into a reactor with tetrafluoroethylene, reacting at 150° C. for 12 h to obtain a reaction product. The reaction product is washed for three times and dried at 60° C. for 24 h to obtain the SrPA/BN.

In step 2, 3 parts of wetting agent, 3 parts of leveling agent, 2 parts of defoamer, 25 parts of anti-rust filler and 12 parts of diluent are added to 42 parts of epoxy resin in a predetermined ratio, followed by grinding for 1 h to obtain a grounded product. Then the grounded product is dispersed with the 3 parts of SrPA/BN added for 20 min to obtain a dispersed product. The dispersed product is filtered and packaged to obtain a component A of the epoxy rust-tolerant coating.

In step 3, 8 parts of composite amine epoxy curing agent and 2 parts of flash rust inhibitor are mixed and stirred in a predetermined ratio to obtain a component B of the epoxy rust-tolerant coating.

In step 4, the component A and the component B are mixed to obtain the epoxy rust-tolerant coating modified by the nanosheets loaded with rust-converting and rust-inhibiting active units configured to be coated directly on a rusted steel substrate.

### Embodiment 3

In step 1, nanosheets loaded with rust-converting and rust-inhibiting active units are prepared by a one-step hydrothermal reaction. Specifically, 4.76 g strontium chloride and 1.36 mL phytic acid in a beaker filled with 100 mL deionized water to obtain a mixed solution, and the mixed solution is added with 2.48 g BN nanosheets, followed by stirring to obtain a mixture. The mixture is transformed into a reactor with tetrafluoroethylene, reacting at 150° C. for 12 h to obtain a reaction product. The reaction product is washed for three times and dried at 60° C. for 24 h to obtain the SrPA/BN.

In step 2, 3 parts of wetting agent, 3 parts of leveling agent, 2 parts of defoamer, 23 parts of anti-rust filler and 13 parts of diluent are added to 45 parts of epoxy resin in a predetermined ratio, followed by grinding for 1 h to obtain a grounded product. Then the grounded product is dispersed with the 1 part of SrPA/BN added for 20 min to obtain a dispersed product. The dispersed product is filtered and packaged to obtain a component A of the epoxy rust-tolerant coating.

In step 3, 9 parts of composite amine epoxy curing agent and 2 parts of flash rust inhibitor are mixed and stirred a predetermined ratio to obtain a component B of the epoxy rust-tolerant coating.

In step 4, the component A and the component B are mixed to obtain the epoxy rust-tolerant coating modified by the nanosheets loaded with rust-converting and rust-inhibiting active units configured to be coated directly on a rusted steel substrate.

### Comparative Embodiment 1

An epoxy rust-tolerant coating modified by modified boron nitride nanosheets is prepared by the same preparation method as the embodiment 1.

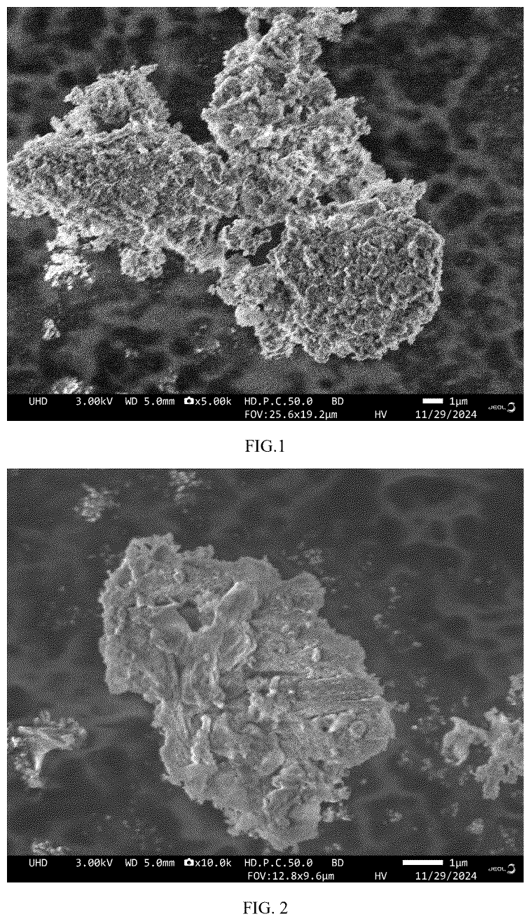

As shown in FIG. 1, FIG. 1 is the scanning electron microscopy (SEM) image of the SrPA/BN prepared according to the embodiment 1 of this disclosure. Composite filler of the SrPA/BN exhibits a sheet-like structure and a surface with accumulation of fine particles, mainly attributed to the deposition of strontium phytate.

As shown in FIG. 2, FIG. 2 is a SEM image of BN nanosheets according to the comparative embodiment 1 of this disclosure. The boron nitride nanosheets exhibit a smoother and flatter surface compared to the SrPA/BN.

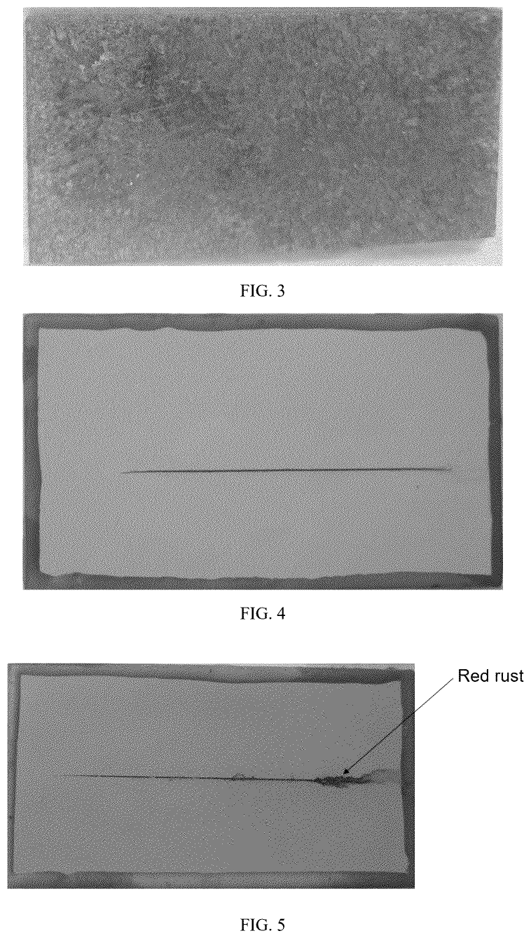

FIG. 3 shows the rusted steel substrate employed in this disclosure. The treatment process of the rusted steel substrate is as follows. A hot-rolled steel substrate is blast-cleaned to obtain a cleaned steel substrate. After blast cleaning, the surface cleanliness of the cleaned steel substrate will reach a Sa 2% level as specified in GB/T 8923.1-2011 (GB/T 8923.1-2011: Preparation of Steel Substrates Before Coating-Visual Evaluation of Surface Cleanliness), and a surface roughness of the cleaned steel substrate will reach a “Medium (G)” grade defined in GB/T 13288.1-2008 (GB/T 13288.1-2008: Surface preparation of steel substrates before coating application—Characteristics of surface profile after blast cleaning). The cleaned steel substrate is then subjected to a 168-hour salt-spray test according to GB/T 1771-2007 (GB/T 1771-2007: Determination of resistance to neutral salt spray of paints and varnishes), followed by a 168-hour damp-heat test according to GB/T 1740-2007 (GB/T 1740-2007: Test method for resistance of paint films to damp heat) to obtain a treated steel substrate. The treated steel substrate is removed and scrubbed by hot water at approximately 50° C. for 3 min with a nylon brush, followed by a second scrubbing with tap water for another 5 min to obtain a scrubbed steel substrate. Then the scrubbed steel substrate is dried at 105±2° C. for 1 h. Loose rust on the surface of the steel substrate is manually removed by using a wire brush, leaving firmly adherent rust retained to obtain a brushed steel substrate. The brushed steel substrate is air-dried, and the surface of the brushed steel substrate is blown clean with compressed air to remove loose dust on the surface, and the coating is performed immediately to obtain the rusted steel substrate.

FIG. 4 is a morphology of neutral salt spray of the epoxy rust-tolerant coating modified by nanosheets loaded with rust-converting and rust-inhibiting active units after being cured for 600 h according to the embodiment 1 of the disclosure. The result shows that no significant rust or blistering is observed on the coating surface.

FIG. 5 is a morphology of neutral salt spray of the epoxy rust-tolerant coating modified by BN nanosheets after being cured for 600 h. The result reveals the presence of red rust on the coating surface according to a comparative embodiment 1 of the disclosure.

The above results indicate that the epoxy rust-tolerant coating modified by the nanosheets loaded with rust-converting and rust-inhibiting active units exhibits superior corrosion resistance compared to the epoxy coating modified by the boron nitride.

Finally, it should be noted that the above descriptions are merely some of the embodiments of the disclosure, and is not used to limit the disclosure. It should be pointed out that for those skilled in the art, any modifications, alterations, variations, or equivalent substitutions made based on this disclosure and within a spirit and principles of the disclosure should be included within the scope of protection of the disclosure.

What is claimed is:

1. A preparation method of an epoxy rust-tolerant coating modified by nanosheets loaded with rust-converting and rust-inhibiting active units, comprising:
step 1, preparing the nanosheets loaded with rust-converting and rust-inhibiting active units by a one-step hydrothermal reaction, comprising: mixing strontium chloride and phytic acid in deionized water in a beaker to obtain a mixed solution, adding boron nitride (BN) nanosheets into the mixed solution, followed by stirring to obtain a mixture, transferring the mixture into a reactor with tetrafluoroethylene, reacting at 150 Celsius degrees (° C. ) for 12 hours (h) to obtain a reaction product; washing and drying the reaction product to obtain strontium phytate-modified boron nitride nanosheets (SrPA/BN) as the nanosheets loaded with rust-converting and rust-inhibiting active units;
step 2, adding a wetting agent, a leveling agent, a defoamer, an anti-rust filler and a diluent to an epoxy resin, followed by grinding for 1 h to obtain a grounded product, dispersing the grounded product with the SrPA/BN for 20 minutes (min) to obtain a dispersed product, and filtering and packaging the dispersed product to obtain a component A of the epoxy rust-tolerant coating;
step 3, mixing and stirring a composite amine epoxy curing agent and a flash rust inhibitor to obtain a component B of the epoxy rust-tolerant coating; and
step 4, mixing the component A and the component B to obtain the epoxy rust-tolerant coating modified by the nanosheets loaded with rust-converting and rust-inhibiting active units configured to be coated directly on a rusted steel substrate.

2. The preparation method as claimed in claim 1, wherein a formula of the epoxy rust-tolerant coating is composed of the component A and the component B;
wherein the component A is made of raw materials in parts by weight comprising: 30-50 parts of the epoxy resin, 0.1-5 parts of the SrPA/BN, 5-30 parts of the anti-rust filler, 0.5-3 parts of dispersant, 1-3 parts of the defoamer, 0.5-5 parts of the leveling agent, 5-15 parts of the diluent; and
wherein the component B is made of raw materials in parts by weight comprising: 5-15 parts of the composite amine epoxy curing agent and 0-3 parts of the flash rust inhibitor.

3. The preparation method as claimed in claim 2, wherein the epoxy resin is at least one of bisphenol A epoxy resin and bisphenol F epoxy resin.

4. The preparation method as claimed in claim 2, wherein the anti-rust filler is at least one of barium sulfate and titanium dioxide.

5. The preparation method as claimed in claim 2, wherein the dispersant is at least one selected from the group consisting of anionic polymeric compound, polymeric carboxylic acid, and siloxane copolymer.

6. The preparation method as claimed in claim 2, wherein the defoamer is polyacrylate.

7. The preparation method as claimed in claim 2, wherein the leveling agent is polyether-modified polysiloxane.

8. The preparation method as claimed in claim 2, wherein the diluent is a mixture of xylene and n-butanol.

9. The preparation method as claimed in claim 2, wherein the composite amine epoxy curing agent is any two or multiple selected from the group consisting of polyamide, aliphatic amines and aromatic amine.
